(19) United States
(12) Patent Application Publication
(10) Pub. No.: US 2019/0314732 A1
(43) Pub. Date: Oct. 17, 2019

(54) Emotionally Responsive Electronic Toy

(71) Applicant: Intellifect Incorporated, San Francisco, CA (US)

(72) Inventors: John A. Lundin, San Francisco, CA (US); Daniel Westfall, Colorado Springs, CO (US)

(21) Appl. No.: 16/382,985

(22) Filed: Apr. 12, 2019

Related U.S. Application Data
(60) Provisional application No. 62/656,765, filed on Apr. 12, 2018.

(51) Int. Cl. A63H 3/00; A63H 3/28

(52) U.S. Cl. CPC A63H 3/001; A63H 3/28; G06K 9/00302; A63H 2200/00; A63H 3/003

(57) ABSTRACT

The disclosure relates to an electronic toy that can convey a personality-driven emotional response based on sensor and/or other input. The toy may comprise a housing having a character likeness and one or more electronic components disposed within the housing. The electronic components may include one or a plurality of sensors that can detect movement and other stimuli and a speaker to output sounds that mimic emotion. The toy may also register movements and other stimuli and log experiences that inform future reactions and personality. The sounds produced by the toy can be programmed by users or external content creators through downloading audio files corresponding to certain movements. The sensory cues can range from simple or complex (e.g., as the toy is shaken multiple times, the responses may become progressively angrier, or progressively friendlier if the toy is patted on the head) making every such electronic toy completely unique.

This application claims priority to U.S. Provisional Patent Application Ser. No. 62/656,765, filed on Apr. 12, 2018, which is incorporated herein in its entirety by this reference thereto.

### TECHNICAL FIELD

The disclosure relates to an electronic toy, and in particular, to an electronic toy that can convey a personality-driven emotional response based on sensor and/or other input.

### BACKGROUND

There are many existing toys that are designed to produce a response when thrown, shaken, or otherwise subjected to impact and/or motion. For example, such toys may include rudimentary designs in which relatively simple mechanical components are arranged to produce a squeak or chirp sound when the toy is subjected to certain physical impact and/or motion. More sophisticated designs may include one or more electronic components that may act in concert to produce a given sound when the one or more electronic components detect certain physical events.

One thing that these existing toy designs have in common is limitation to a handful of preprogrammed responses and lack of any real personality that could foster a deeper emotional bond or connection between person and toy. Moreover, in addition to serving to amuse, toys often play an important therapeutic role to children and adults alike (e.g., stress relief). Nonetheless, despite the fact that there is substantial research to show that users desire emotional connection and engagement with toys and other products, existing designs fall short in meeting such needs.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

According to various aspects, the disclosure generally relates to an electronic toy that can convey a personality-driven emotional response based on sensor and/or other input. For example, as will be described in further detail herein, the electronic toy may be designed to be funny and engaging such that the toy may offer amusement, therapeutic, and other value. The electronic toy as described herein may be configured to produce plentiful, rich, and psychologically attuned responses when users interact with the toy and based on the types of physical interaction with the toy. The electronic toy as described herein may also be designed to pick up on the emotional expression of the user and offer an attuned, psychologically realistic response in return as well as realistic “emotional memory” that may provide an even more realistic “personality” for the toy, leading to deeper engagement, more enjoyment, and potential therapeutic value.

For example, the toy may be designed to help users discharge aggression and reduce stress by providing a safe, appropriate, and enjoyable outlet for such emotions. The electronic toy as described in further detail herein was created using life-like and compelling personality structures based on established research-based personality structure models, as well as intuitive, organic models of interaction that users will respond to on both conscious and unconscious levels. Human beings are hard wired to be curious about and interact with personalities. Harnessing the power of human interaction at its most basic level, with minimal cost and to maximum effect, the electronic toy described herein is a technology that has tremendous potential in the toy-meets-artificial intelligence (AI) realm.

Other objects and advantages associated with the various aspects and/or embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary wireless communication system in which one or more emotionally responsive electronic toys may operate, according to various aspects.

FIG. 2A-2B illustrate exemplary conceptual designs for an emotionally responsive electronic toy, according to various aspects.

FIG. 3 illustrates exemplary components associated with an emotionally responsive electronic toy, according to various aspects.

FIG. 4A-4B illustrate exemplary design elements associated with an emotionally responsive electronic toy, according to various aspects.

FIG. 5A-5C illustrate additional exemplary design elements associated with an emotionally responsive electronic toy, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

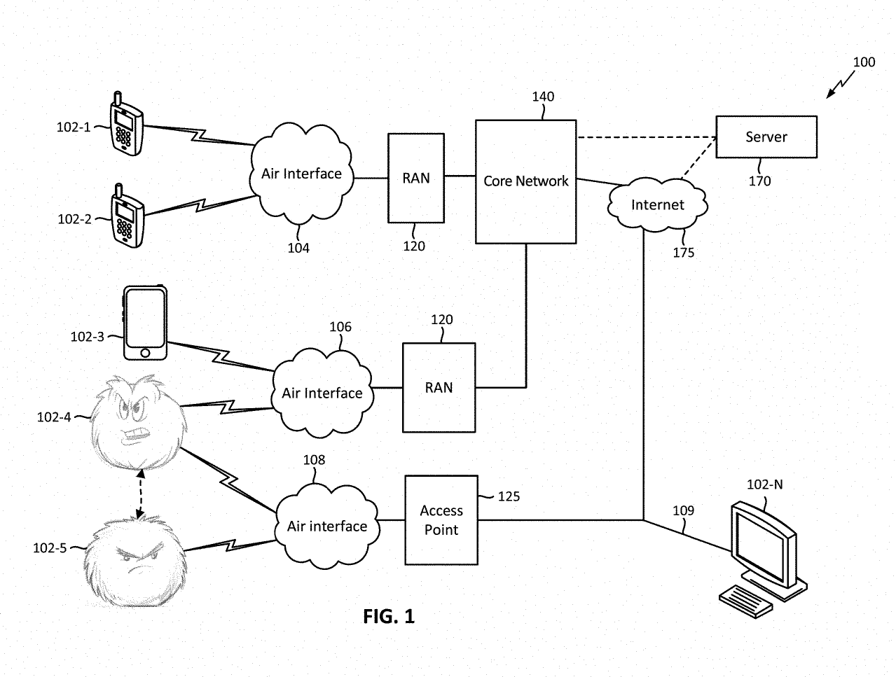

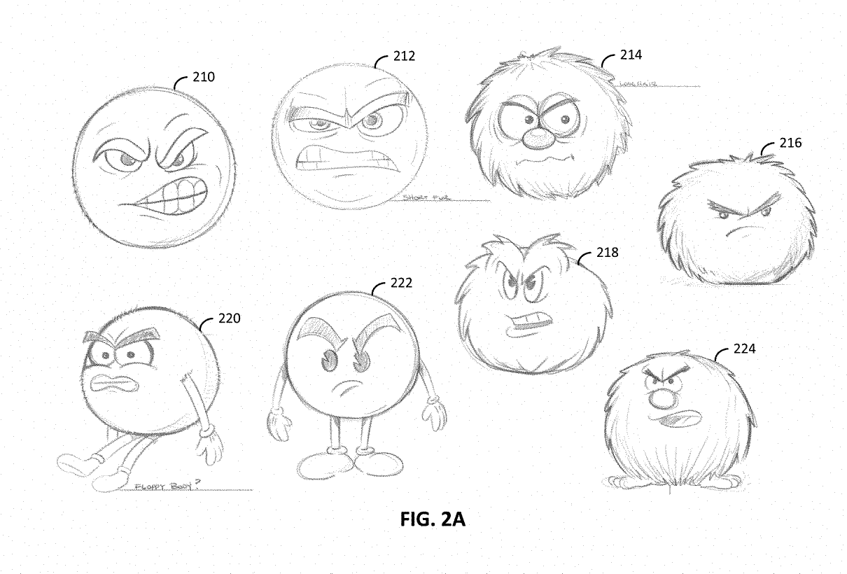

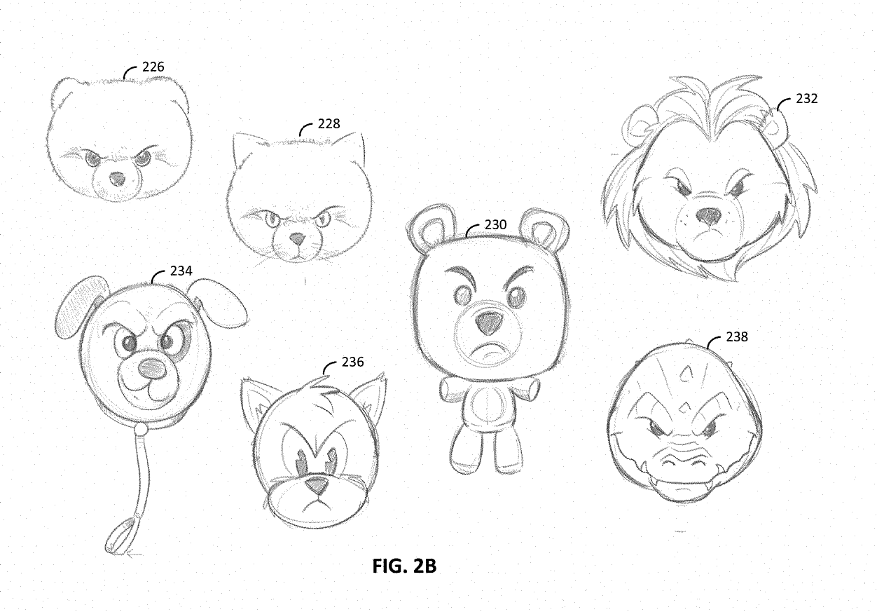

According to various aspects, FIG. 1 illustrates an exemplary wireless communication system 100 in which one or more emotionally responsive electronic toys may operate. In various embodiments, the wireless communications system 100 may contain various UEs, including UE 102-1, UE 102-2, UE 102-3, UE 102-4, UE 102-5, UE 102-N, collectively referred to herein as UEs 102. The UEs 102 can include cellular telephones, smart phones, personal or mobile multimedia players, personal data assistants, laptop computers, personal computers, tablet computers, electronic devices, and so on. For example, in FIG. 1, UE 102-1 and 102-2 are illustrated as cellular calling phones, UE 102-3 is illustrated as a cellular touchscreen phone or smartphone, UEs 102-4 and UE 102-5 are illustrated as emotionally responsive electronic toys that will be described in further detail below starting with FIG. 2, and UE 102-N is illustrated as a desktop computer.

Referring to FIG. 1, the UEs 102 may communicate with an access network (e.g., a radio access network (RAN) 120 that implements a particular radio access technology (RAT), a network accessible through a wired and/or wireless access point 125, etc.) over a physical communications interface or layer, shown in FIG. 1 as air interfaces 104, 106, 108 and/or a direct or indirect wired connection 109. The air interfaces 104 and 106 can comply with a given cellular communications protocol (e.g., CDMA, EV-DO, eHRPD, GSM, EDGE, W-CDMA, LTE, etc.), while the air interface 108 can comply with a wireless local area network (WLAN) protocol (e.g., IEEE 802.11). Although not explicitly shown in FIG. 1, the RAN 120 may include various access points that can serve UEs over air interfaces, such as UEs 102-1 . . . 4 over the air interfaces 104 and 106. Each access point in the RAN 120 can be referred to as an access node or AN, an access point or AP, a base station or BS, a Node B, an evolved Node B, an eNodeB or eNB, and so on. These access points can be terrestrial access points (or ground stations) or satellite access points. The RAN 120 may be configured to connect to a core network 140 that can perform various functions, as would be apparent to a person having ordinary skill in the art.

In various embodiments, the RAN 120 may be configured to bridge circuit-switched (CS) calls between UEs serviced via the RAN 120 and other UEs serviced via the RAN 120 or an altogether different RAN. In various embodiments, the RAN 120 may also be configured to mediate an exchange of packet-switched (PS) data with external networks such as Internet 175. The Internet 175 may generally include various routing agents and processing agents (not explicitly shown in FIG. 1 for sake of convenience). In FIG. 1, UE 102-N is shown as connecting to the Internet 175 via the wired connection 109 (i.e., separate from the core network 140, such as over an Ethernet connection to an 802.11-based wireless local area network). The Internet 175 can thereby bridge packet-switched data communications (including data associated with video calls) between UE 102-N and UEs 102-1 to 102-5 via the core network 140. Also shown in FIG. 1 is the access point 125 separate from the RAN 120. The access point 125 may connect to the Internet 175 independent from the core network 140 (e.g., via an optical communication system, a cable modem, etc.). The air interface 108 may serve UE 102-4 or UE 102-5 over a local wireless connection, such as IEEE 802.11 in an example. UE 102-N is shown as a desktop computer with the wired connection 109 to the Internet 175, such as a direct connection to a modem or router, which can correspond to the access point 125 in one example (e.g., a WLAN router with wired and/or wireless connectivity may correspond to the access point 125).

Referring to FIG. 1, a server 170 is shown as connected to the Internet 175, the core network 140, or both. The server 170 can be implemented as multiple structurally separate servers as in a cloud configuration, or alternately may correspond to a single server. The server 170 may be configured to support one or more services for the UEs 102 that can connect to the server 170 via the core network 140 and/or the Internet 175. For example, in various embodiments, the emotionally responsive electronic toys 102-4, 102-5 may be configured to appropriately communicate with the server 170 to program or download one or more sounds that the emotionally responsive electronic toys 102-4, 102-5 are configured to produce when subjected to physical impact or motion, verbal interactions, to acquire software updates, etc.

Furthermore, as depicted by the dashed arrow in FIG. 1, the emotionally responsive electronic toys 102-4, 102-5 may have capabilities to wirelessly discover and/or communicate with one another in certain embodiments, whereby the electronic toys 102-4, 102-5 may engage in amusing or interesting dialogue (e.g., parody material where the electronic toys 102-4, 102-5 have the likeness of well-known personalities, such as political rivals, celebrities, fictional characters, etc.). Furthermore, the wireless communication capabilities may enable wireless interaction with one or more objects in the real world, object identification (e.g., in an augmented reality context), data exchanges, and/or other suitable functions that will be apparent based on the various aspects and embodiments to be described more fully below.

According to various aspects, FIG. 2A-2B illustrate exemplary conceptual designs for an emotionally responsive electronic toy, which may optionally be configured with wireless communication capabilities as described above with respect to FIG. 1. For example, FIG. 2 illustrates various generic character designs for the body of the emotionally responsive electronic toy, including a smooth plush version 210, a stitched, short fur, and/or fuzzy version 212 having a similar likeness as the smooth plush version 210, several long hair versions 214, 216, 218 with different expressions and facial features, a floppy body version 220, a posable version 222 with semi-rigid flexible limbs, and a standing version 224 with feet. Referring to FIG. 2B, additional conceptual designs for the emotionally responsive electronic toy may include pets, such as a grumpy bear 226, an angry cat 228, a dog 234 with a leash accessory, and a cartoon cat 236. Still further conceptual designs may include zoo animals, such as a bear 230 that has also a full body and limbs, a lion 232, and a crocodile 238. Accordingly, those skilled in the art will appreciate that the emotionally responsive electronic toy described herein may be designed with any suitable likeness, such as a custom pet version having markings similar to a user's own pet, celebrities, political personalities, fictional characters, and so on.

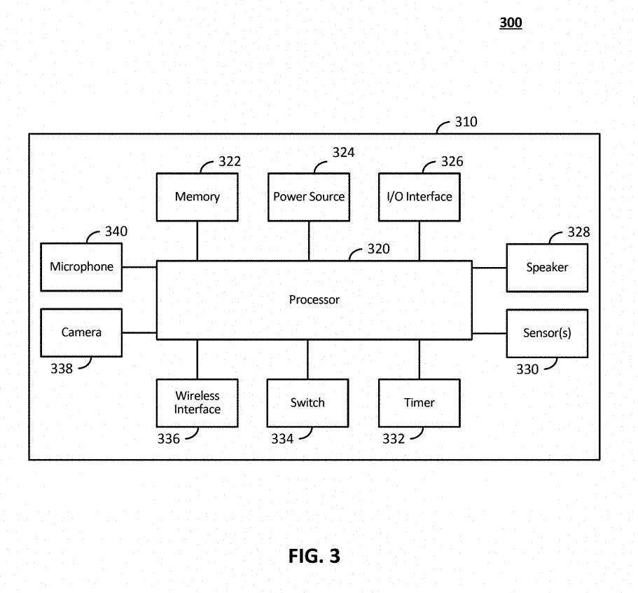

According to various aspects, regardless of the particular character design, the emotionally responsive electronic toy may have one or more electronic components housed therein. For example, FIG. 3 illustrates one example arrangement of a device 300 that can be implanted in the body of such an emotionally responsive electronic toy. As shown therein, the device 300 includes a housing 310 and a processor 320 (e.g., one or more ASICs, a digital signal processor (DSP), a general purpose processor, etc.) coupled to at least a memory 322 (e.g., RAM, ROM, EEPROM, flash cards, or any memory common to computer platforms), a power source 324, an input/output (I/O) interface 326, a speaker 328, and one or more sensors 330 from a group of sensors including an accelerometer, a gyroscope, an impact sensor, a piezoelectric device, a light sensor, a heartbeat sensor, a blood oxygen sensor, a temperature sensor, a touch sensor, a motion sensor, and a microphone. The sensors 330 employed can be any or all of the noted sensors or other sensors as would occur to those skilled in the art which will sense a particular movement or physical or health attribute, and transmit an electric signal relative thereto to the operatively engaged processor 320 and memory 322 and system software running to the task of receiving one or a plurality of sensor electronic signals, and causing actions by the reactive toy.

For example, in various embodiments, the housing 310 may be constructed from plastic or any other material that may be suitable to stabilize and protect the electronic components housed therein and exemplary configurations for the processor 320 and the memory 322 are provided above. In various embodiments, the power source 324 may comprise one or more disposable or rechargeable batteries (e.g., three AAA batteries, a CR2032 button-type battery, etc.), the I/O interface 326 may support wired local connections to peripheral devices (e.g., a USB connection, a mini USB or lightning connection, a headphone jack, graphics ports such as serial, VGA, HDMI, DVI or DisplayPort, audio ports, etc.) and/or to a wired access network (e.g., via an Ethernet cable or another type of cable that can function as a bridge to the wired access network such as HDMI v1.4 or higher, etc.).

The speaker 328 may be configured to produce audio outputs under direction of the processor 320 and based at least in part on input to the one or more sensors 330, which may comprise an accelerometer and/or gyroscope that can be used to detect multi-axis movement and/or impact, an impact sensor that can detect impact using a piezoelectric device or other suitable means, a light sensor, contact sensors, compression sensors, physiological sensors such as a heartbeat sensor, an oxygen saturation sensor, a temperature sensor, etc.

Additionally, in various embodiments, the electronic components that are provided in the housing 310 and coupled to the processor 320 may further include a timer 332 and a switch 334 that can be used to measure time and toggle between certain states or modes (e.g., between a family-friendly mode and an adult mode in which the sounds output via the speaker 328 may be more crude, profane, offensive, etc.). Furthermore, in various embodiments, the electronic components may include a wireless interface 336, which may in turn include one or more wireless transceivers for communication in accordance with a local wireless communications protocol (e.g., WLAN, Wi-Fi Direct, Bluetooth, etc.) and/or one or more wireless transceivers for communication with a cellular RAN (e.g., via CDMA, W-CDMA, time division multiple access (TDMA), frequency division multiple access (FDMA), Orthogonal Frequency Division Multiplexing (OFDM), GSM, or other protocols that may be used in a wireless or data communications network).

The electronic components may further include a camera or lens 338 that can capture images suitable for facial recognition, determining an emotional state of a user, etc. as well as a microphone 340 that can capture audio inputs suitable for voice recognition and/or voice control, recording custom sounds to be output via the speaker 328, determining the emotional state of the user, etc.

Although not explicitly illustrated as such in FIG. 3, the various electronic components 322-340 as well as the sensors 330, can be coupled to communicate electronically with the processor 320 via a bus, one or more wires, and/or another suitable interconnect, and moreover, one or more of the electronic components 322-340 may be provided in a separate housing. For example, as will be described in further detail below, FIG. 4A illustrates one arrangement in which an emotionally responsive electronic toy 450 has a speaker 428 coupled to a housing 410 in which other electronic components are disposed and operatively electronically engaged.

Having provided the above overview of the electronic components that may be provided within the emotionally responsive electronic toy, a high-level overview of various functions that may be realized using such electronic components will now be described. Those skilled in the art will appreciate that, where certain functions are described below, one or more of the electronic components shown in FIG. 3 may in fact be configured to implement appropriate functionality to carry out such functions.

According to various aspects, an emotionally responsive electronic toy configured as described herein may generally produce pre-programmed sounds that mimic emotion in response to movement and/or other suitable stimuli (e.g., the toy may say “ouch” when the sensors 330 detect a punch). The emotionally responsive electronic toy may also register the movements and other stimuli (e.g., time of day, times since last touched, light, sound, etc.) and store in the memory 322 a log of experiences that inform future reactions and personality. In various embodiments, the reactions to external stimuli (e.g., being shaken or pet) can be programmed by users or external content creators, through downloading of audio files that correspond to movements of the device.

For example, the I/O interface 326 may include a USB interface that can be used to connect the emotionally responsive electronic toy to a client computer used to download the audio files, software updates, and/or other suitable data from an online source. Alternatively and/or additionally, the emotionally responsive electronic toy may download appropriate audio files, software updates, etc. directly via the wireless interface 336 when suitably configured to do so. The sensory cues for the sounds can be very simple or complex (e.g., the emotionally responsive electronic toy may become progressively angrier after being shaken multiple times or progressively friendlier if pet, which may be detected by an appropriate sensor 330 positioned on the top of the toy's head).

According to various aspects, the emotionally responsive electronic toy may also have an “emotional memory.” For example, if the emotionally responsive electronic toy experiences hurt feelings, the emotionally responsive electronic toy may not heal and forgive until the timer 332 determines that a certain amount of time has elapsed since the feelings were hurt. The sounds output via the speaker 328 can also correspond to various personalities, celebrities, relatives, moods, characters, etc., making the emotionally responsive electronic toy both a toy and a platform for endless creativity. Both kids and adults can have fun with the emotionally responsive electronic toy.

There may also be options to customize the emotionally responsive electronic toy to the look and personality of a favorite pet, a relative, etc. For example, a user may purchase one or more memory chips or other suitable expansion devices that contain one or more sound sets, behavior profiles, etc. modeled around a particular personality, wherein the memory chips or expansion devices can then be connected to the toy to customize the responses that the toy produces in response to various motions, impacts, interactions, etc.

In another example, a user may be given the option to create custom personalities through defining certain traits via an online or other suitable interface (e.g., the user could fill in a child's name, a boss' name, or other suitable identification information as well as certain personality traits, such as morning person, easy to anger, likes pizza, same birthday, etc. to thereby match the custom personality to a real person or animal). Further still, the user may provide a photograph, artwork, drawing, etc. of a person, animal, imaginary character, etc. and the toy may be custom created to have the likeness as depicted in the provided photograph, artwork, drawing, etc. Furthermore, the emotional responsiveness may have psychological benefits as a stress reliever or empathic character.

Personality can also be molded based on interaction with it. Say for instance, input from the sensors which is communicated to the processor and software running to the task discern physical and/or verbal treatment of the toy, indicates according to the software and rules or other behavior perameters correlated to the sensor inputs, that the reactive toy is treated well over time. Then the system software would actuate the reactive toy to be generally nicer and in a better mood in interacting with the user. If the reactive toy sensors transmit signals interpreted by the software and system that it is being hit often, the toy would develop a more grouchy, aggressive personality which would be initiated by software routines based on the perceived input from the sensors.

Other variables can come into play as well. If for example the sensors communicate signals interpreted by the system and software that the toy is treated better in the morning time, the reactive toy may be happier in the mornings. If the sensors communicate signals interpreted by the software and system that the user tends to be neglect the reactive toy in the evenings, the software running to the task would render the reactive toy might to react to the user in a grouchier manner. In other words, variables in the signals communicated from the various sensors positioned on the reactive toy communicated to the software and held in memory, would also be employable to form a “long-term” memory and resulting actions by the toy therefrom, amounting what in human terms would be environmental factors that mold human personalities.

Kids and adults alike are naturally interested and tuned into the deeper personality aspect of what they are interested in, making interactions with the emotionally responsive electronic toy deeply compelling. Both kids and adults will become interested and attached to their emotionally responsive electronic toys in deeper ways than normal toys. “My [Toy's Name] is not a morning person,” a child might say, like they would about their cat or dog. Incidentally, the emotionally responsive electronic toy can also be programmed to have a personality that is similar to their pet, family member, friend, etc.

According to various aspects, the sounds output via the speaker 328 can be programmed online, selected from a list of pre-programmed sounds, and/or programmed based on a “personality set” that may comprise a coherent set of sounds or words that is organized around a personality or mood structure. For example, the sounds could convey a particular mood (e.g., grumpy) or a particular personality (e.g., histrionic). For example, a grumpy version could give grumpy responses to being touched or shaken as follows:

If shaken gently, “Ugh, leave me alone.”

If shaken again, “Did you not hear me the first time?”

If shaken yet another time, “WILL YOU LEAVE ME ALONE?! AAAAHHH!”

Children of all ages will love being able to “get the goat” of the emotionally responsive electronic toy. Additionally, the emotionally responsive electronic toy may serve complex and important psychological processes. For example, when someone is feeling irritated, irritating others can be fun and cathartic. If an irritated child had the emotionally responsive electronic toy, however, the child could irritate the toy instead of taking out frustrations on their friends or family. Additionally, the friends or family would have a window into how the person is feeling, as would the person themselves. This process is referred to in psychology as “projective identification,” which is a fundamental, basic tool of emotional development whereby a child may project their feelings onto others to see how they handle it. If the adult can handle it, and even names it, the child can learn that their feelings are tolerable, and that there is even a word for them. This allows the child to have a healthy relationship with their feelings, instead of being afraid and repressing them, for example, which leads to all kinds of problems. The emotionally responsive electronic toy is designed with these and other deep, fundamental, and compelling psychological concepts in mind.

Additionally, adults will enjoy the emotionally responsive electronic toy, which can be programmed according to their whims for amusement and/or therapeutic value. For example, interactions with an “adult” version might go something like this:

If shaken once, “Umm . . . ”

If shaken twice, “Screw you!”

If shaken three times, “If you don't put me down I'm gonna punch you in the nuts.”

In various embodiments, the emotionally responsive electronic toy may be outfitted with one or a plurality of sensors 330 on various parts of its body to give different reactions. For example, a pat on the head could soothe the emotionally responsive electronic toy (“Ahhh, thanks.”) following earlier movements, impacts, etc. that irritated the emotionally responsive electronic toy. A hug or squeeze might elicit a different response depending on the personality of the toy. Bright light or loud noises can make the emotionally responsive electronic toy happy or grouchy.

Additionally, surface mounted sensors 330 could be used to measure physiological parameters of an individual playing with the toy. For example, with a heart rate sensor operatively engaged to the toy, such as a microphone or skin contact sensor, or other heartbeat sensor, an increase in the heartbeat rate of a child holding the toy, discerned by software or the processor receiving signals from the sensors, might indicate fear in the child and elicit an appropriate calming remark from the toy. Such a toy could be useful in a doctor's office for obtaining patient physiological parameters in a non-frightening way. Furthermore, the emotionally responsive electronic toy may also be equipped with speech recognition capabilities which are well known conventionally to employ voice patterns and the like to be able to discern truth and emotion, through cloud-based or internal software, allowing personality to be expressed through words and allowing users to engage in verbal interactions with the emotionally responsive electronic toy.

In various embodiments, the emotionally responsive electronic toy may automatically activate when shaken, or alternatively activate when a button is pushed. When first shaken the rapid or sharp movements would be sensed by a sensor such as an accelerometer or camera or other movement sensor which would output an electronic signal discernable as shaking by the software running to the task discerning shaking. In response, a particular pre-programmed sound from a first set of sounds may be produced, and when shaken a second time within a threshold period of time discerned by a timer after the first shake, another sound from a second set of sounds is produced. This process may repeat each time the toy is shaken, as appropriate emotional sound clips and responses are produced. Timing of the responses may be designed to reflect human's natural timing around responding and digesting information, making for ideally relatable interaction and realism (e.g., comic timing, thinking, taking time to respond appropriately, etc.).

Furthermore, in various embodiments, sounds may be linked to one another across sets (e.g., sound 1A from set 1 may feed into sound 2A from set 2, etc.). If the toy is shaken vigorously or hit hard, the sequence of sound clips may be varied accordingly (e.g., sound clips may jump from the first set of sound to the fifth). A sensor on the head may register affectionate (pats) and respond appropriately. Furthermore, in various embodiments, the emotionally responsive electronic toy may include one or more accessories that contain one or more additional sensors 330.

For example, referring again to FIG. 2B, the leash accessory associated with the dog 234 may include one or more motion sensors, impact sensors, cameras, or the like that may provide the ability to discern exactly how the user is interacting with the toy and software running to the task of responding will thereby generate appropriate responses. In another example, the accessory may be a necktie, jewelry, a hat, and/or any other suitable item. Accordingly, the sensor(s) 330 can be suitably placed on any suitable part or parts of the toy's body and emotional responses can correspond to the particular body part that is impacted, moved, etc. For example, the toy may say “If you hold my hand I will feel better.” In another example, the toy might make a flatulence sound if the user pushes the toy's belly. In still another example, if the user rubs the toy's head, the toy may feel soothed or get annoyed with variations in the emotional response(s) depending on the toy's configured personality.

Furthermore, the emotional memory and personality may contain information about body parts (if any), body sensations, injuries, and/or symbolic value such that emotional responses to motion, impact, verbal interaction, nonverbal cues (e.g., a user's facial expression) may vary depending on the experiences that are logged within the emotional memory (e.g., research shows that humans unconsciously contain certain memories in their bodies, and bodily memories can affect a person's personality, how a person expresses themselves, how assertive a person is, and so on, qualities that may be modeled in how the emotionally responsive electronic toy behaves).

In various embodiments, there may be multiple “channels” of sound clips, which may include “family friendly” and adult language, which can be toggled between using a three mode off/½ switch on the battery casing. Light, sound, and motion sensors, as well as facial and vocal recognition, will also feed into processor and memory to increase the complexity of personality and interactive ability, further deepening engagement, interactive, and therapeutic abilities. The emotionally responsive electronic toy may also have the ability to connect wirelessly to the Internet, a computer, other toys, and other mobile devices to acquire software updates, download fresh content, interact with other toys, and so on (e.g., toys may download fresh or relevant content that is professionally or user-created).

With wireless technology, the emotionally responsive electronic toy may have the ability to engage in amusing or interesting dialogue with other toys or figures (e.g., political parody-type material) and support the ability to wirelessly interact with or identify objects in the real world, exchange data, and respond in appropriate, entertaining, or helpful ways, even offering advice, like a personal assistant. They may be able to interact wirelessly in the context of a game, i.e. a real life scavenger hunt or game where the user finds other reactive toys to make “friends” with. These features would also interact with the “mood” programming of the reactive toy. For example, the more reactive toys it “connects” with, the better its mood and more cheerful its personality

According to various aspects, FIG. 4A and FIG. 4B illustrate exemplary design elements associated with an emotionally responsive electronic toy configured as described in further detail above. For example, referring to FIG. 4A, the emotionally responsive electronic toy 450 has a speaker 428 coupled to a housing 410 in which other electronic components are disposed via one or more wires. Alternatively, the speakers 428 and the other electronic components may all be provided within one housing 410. In one optional configuration, as shown in FIG. 4B, the emotionally responsive electronic toy 450 may include a charging port (not explicitly shown) that can mate with a charging source 462 on an appropriate base 460, shown as feet in FIG. 4B.

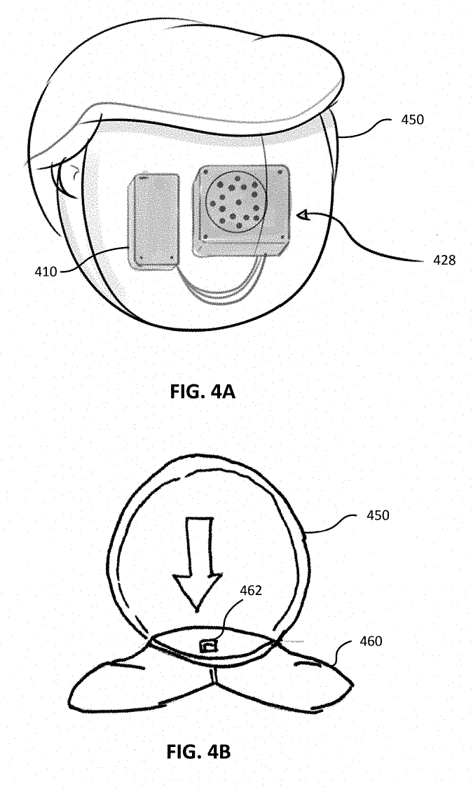

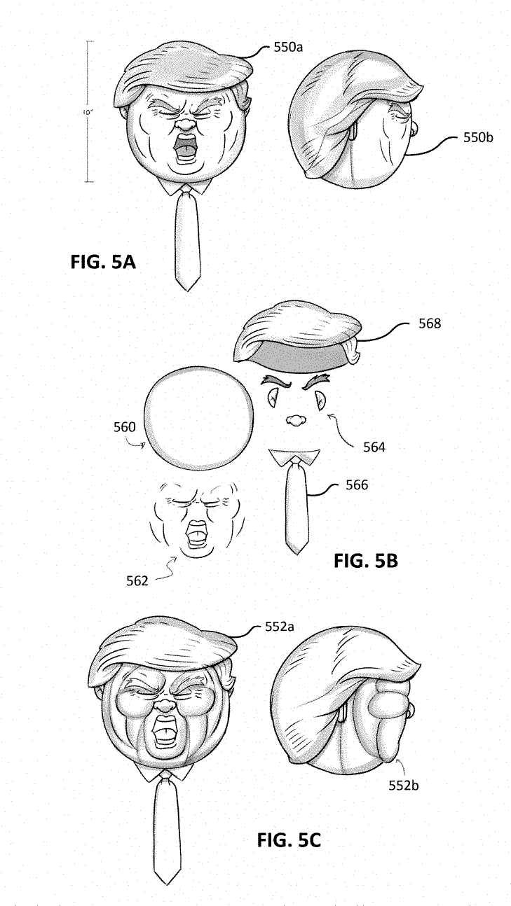

According to various aspects, FIG. 5A-5C illustrate additional exemplary design elements associated with the emotionally responsive electronic toy 450. For example, FIG. 5A illustrates the emotionally responsive electronic toy 450 according to a face view 550a and a profile view 550b. As shown in FIG. 5B, the version depicted in FIG. 5A may be constructed from a smooth plush pillow 560 such that printed graphics 562 can be created to represent any suitable character likeness and suitably applied to the plush pillow 560. Furthermore, additional plush elements 564 for the eyes, nose, etc. as well as hair 568 can be stitched to the plush pillow 560 after the printed graphics are applied. In the particular configuration shown in FIG. 5B, the emotionally responsive electronic toy also has a fabric tie 566, which could be used to hold the toy, swing the toy around, throw the toy, etc., thus providing another way to impart motion and impact.

Furthermore, whereas FIG. 5A and FIG. 5B illustrate a design based on interchangeable printed graphics 562, plush elements 564, and hair 568 that can be used to create any suitable character likeness, FIG. 5C illustrates a stitched version according to a face view 552a and a profile view 552b. Although the versions shown in FIG. 5A and FIG. 5C may be functionally identical, the stitched version may provide a more dimensional look and feel that may be more appealing to some consumers (at a potentially greater cost and at the expense of interchangeability).

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions and toy reactions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. An emotionally responsive electronic toy, comprising:
a body;
a housing within said body, said housing including a processor, a memory, and a power source;
at least one sensor for detecting a stimulus;
a speaker;
said memory configured for storing sounds that mimic emotion; and
said speaker configured to produce an audio output of said sounds that mimic emotion under direction of said processor based on input from the at least one sensor.

2. The emotionally responsive electronic toy of claim 1, further comprising:
a microphone for capturing audio inputs for voice recognition or voice control, recording custom sounds, or determining the emotional state of a user.

3. The emotionally responsive electronic toy of claim 1, further comprising:
a camera or lens for capturing images for facial recognition, or determining the emotional state of a user.

4. The emotionally responsive electronic toy of claim 1, wherein the at least one sensor includes, an accelerometer, a gyroscope, an impact sensor, a piezoelectric device, a light sensor, a heartbeat sensor, a blood oxygen sensor, a temperature sensor, a touch sensor, a motion sensor, or, a microphone.

5. The emotionally responsive electronic toy of claim 1, further comprising:
a switch configured to toggle between a first and second set of sounds that mimic emotion.

6. The emotionally responsive electronic toy of claim 1, further comprising:
a wireless interface for connecting said toy to the internet, a computer, other emotionally responsive electronic toys, or mobile devices.

7. The emotionally responsive electronic toy of claim 1, further comprising:
an accessory containing a sensor for detecting an additional stimulus.

8. The emotionally responsive electronic toy of claim 1, further comprising:
speech recognition software allowing users to engage in verbal interactions with said emotionally responsive electronic toy.

9. The emotionally responsive electronic toy of claim 1, further comprising:
a timer, wherein said audio output of said sounds that mimic emotion change as a result from an input from said timer.

10. The emotionally responsive electronic toy of claim 1, further comprising:
a charging port configured to mate with a charging source.

11. The emotionally responsive electronic toy of claim 1, where in movements and other stimuli are registered and said memory stores a log of experiences that used to modify future reactions and personality.

12. The emotionally responsive electronic toy of claim 1, wherein said sounds that mimic emotion comprise a set of sounds or words organized around a personality or mood structure.

13. The emotionally responsive electronic toy of claim 1,
wherein said sounds that mimic emotion progressively increase as a result of a detected stimulus.

14. A method of conveying a personality-driven emotional response using an emotionally responsive electronic toy of claim 1, comprising:
storing sounds that mimic emotional response;
detecting a stimulus;
outputting said sounds that mimic emotional response based on said detected stimulus.

15. The method of conveying a personality-driven emotional response of claim 14, further comprising:
outputting a modified sound based on an amount of time elapsed since a detected stimulus.

16. The method of conveying a personality-driven emotional response of claim 14, wherein
said outputting comprises a pre-programmed sequence of responses.

17. The method of conveying a personality-driven emotional response of claim 16, wherein
said sequence of responses is adjusted based on a detected stimulus.

18. The method of conveying a personality-driven emotional response of claim 14, wherein said stimulus comprises a motion, a movement, a force, a light, a sound, a temperature, a heartbeat, an impact, or a touch.

19. The method of conveying a personality-driven emotional response of claim 14, wherein
said outputting comprises a progressive increase in intensity based on a detected stimulus.

20. The method of conveying a personality-driven emotional response of claim 14, further comprising:
detecting a second stimulus and modifying said sounds that mimic emotional response based on said detected second stimulus.
